(19) United States
(12) Patent Application Publication
(10) Pub. No.: US 2002/0065183 A1
(43) Pub. Date: May 30, 2002

(54) Process and apparatus for folding sheets

(75) Inventors: Ernst Luthi, Brittnau (CH); Robert Glur, Brittnau (CH)

Correspondence Address: OLIFF & BERRIDGE, PLC, P.O. BOX 19928, ALEXANDRIA, VA, 22320, US

(73) Assignee: HUNKELER AG, Wikon (CH)

(21) Appl. No.: 09/994,662

(22) Filed: Nov. 28, 2001

(30) Foreign Application Priority Data
Nov. 28, 2000 (EP) 00 125 970.4

(51) Int. Cl. B31F 1/08

(52) U.S. Cl. 493/424

(57) ABSTRACT

The invention relates to a process and an apparatus for folding sheets (2), in particular printed sheets. A sheet (2) which is fed in a state in which it lies horizontally in a feed plane (7) is fed to at least two incipient-folding rollers (4) by a rectilinear knife (6), which can be moved perpendicularly to the feed plane (7), and is received between the incipient-folding rollers (4) in order to form a fold (8). The sheet is then conveyed away in the direction of the fold without being completely closed. The sheets are conveyed away by at least two removal rollers (5), by means of which the fold is also completed. The sheets are advantageously folded and conveyed away in one process step in the case of the invention, an additional opening step prior to the further processing of the sheet being dispensed with.

### BACKGROUND OF THE INVENTION

1. Field of Invention

The invention relates to a process and an apparatus for folding sheets.

2. Description of Related Art

For the purpose of folding sheets, e.g. within the context of producing a printed product in which the constituent parts are bound and/or inserted one inside the other, it is known for one sheet half to be folded over onto the other and for the sheet to be smoothed along the folding line. Also known are knife folders, in which a planar sheet is bent into an upright position from beneath or above by a rectilinear knife is received between two or more rollers oriented parallel to one another, and to the knife, and is conveyed between said rollers by virtue of the latter being rotated. The fact that the rollers are pressed against one another in each case in pairs means that a fold is formed as the sheet is conveyed through. In the case of such folding units, the conveying direction of the folded sheet is perpendicular to the original conveying plane. It is thus necessary for the folded sheet to be fed to the original conveying plane again in a further operating step. Furthermore, for further processing of the sheet, e.g. for inserting a plurality of sheets one inside the other and, if appropriate, for subsequent stapling, it is usually necessary for the sheet halves, which are located one upon the other following the folding operation, to be open again, which requires an additional operating step. A further problem with known knife folders is that the activated knife presses the incipient-folding rollers apart from one another, with the result that further rollers arranged parallel to the incipient-folding rollers are necessary for clean folding. This is problematic, in particular, in the case of relatively thick sheets which comprise a plurality of individual sheets located one upon the other or thick paper.

### SUMMARY OF THE INVENTION

The object of the invention is thus to specify a process and an apparatus for folding a sheet which avoid the abovementioned problems. In particular, the intention is for the process and the apparatus to manage with the smallest possible number of operating steps and components.

The object is achieved by a process for folding sheets having the features of claim 1. The object is also achieved by an apparatus for folding sheets having the features of claim 9. Advantageous developments of the process and of the apparatus are described in the subclaims, the description and the drawings.

According to the invention, a sheet which is fed in a state in which it lies horizontally in a feed plane is fed to at least two incipient-folding rollers by a rectilinear knife, which can be moved perpendicularly to the feed plane, and is received between the incipient-folding rollers in order to form a fold. The sheet is then conveyed away in the direction of the fold without being completely closed. The sheets are conveyed away by at least two removal rollers, by means of which the fold can also be completed. The sheets are advantageously folded and conveyed away in one process step, in the case of the invention, an additional opening step prior to the further processing of the sheet being dispensed with. In conjunction with the invention, sheet is intended to mean one or more sheets positioned one above the other or a sheet which has already been folded at least once.

The knife is aligned, for example, horizontally and raises the sheet from bottom to top to the incipient-folding rollers or vice versa. Incipient-folding rollers, which are preferably arranged parallel to one another, can be rotated about an axis of rotation which runs parallel to the knife. They form a fold which is aligned parallel to the knife. The incipient-folding rollers convey the sheet further perpendicularly to the feed plane, e.g. in the upward or downward direction. In this case, however, its ends rest, for example, on a support, in particular a feed arrangement used for feed purposes, with the result that the sheet is not completely closed. The sheet is then received between at least two removal rollers and is conveyed away by the latter in the direction of the fold, i.e. parallel to the incipient-folding rollers and/or to the feed plane. The axes of rotation of the removal rollers are directed perpendicularly to the feed plane. The removal rollers may be arranged above or beneath the incipient-folding rollers. Alternatively, or in addition, removal rollers may be arranged to the side of the incipient-folding rollers, with the result that they receive a sheet from the incipient-folding rollers not above or beneath the incipient-folding rollers but downstream of the incipient-folding rollers, as seen in the folding direction. This is particularly suitable for paper formats in which half the sheet width is smaller than the distance of the feed plane from that side of the incipient-folding rollers which is directed away from the feed plane, with the result that the sheets would be closed when received by removal rollers arranged on this side.

Since the sheet is not completely closed as it is folded, it is possible to dispense with an opening step prior to the further processing of the sheet. The folded, not completely closed sheet is preferably pushed directly onto a saddle as it is conveyed away.

Since the removal rollers are functionally separate from the incipient-folding rollers, it is also advantageously possible for the sheets to be conveyed away in the original feed direction. This is particularly advantageous for continuously operating processing arrangements in which a changeover in the direction of flows is to be avoided. Alternatively, however, it is also possible for the sheet to be fed perpendicularly to the knife and/or folding direction.

In particular, in the case of relatively thick sheets or of sheets comprising a plurality of layers, the removal rollers are also advantageously utilized for definitive folding, in that they receive the fold formed by the incipient-folding rollers and complete the fold in one operation as the sheets are conveyed away or by the sheets being conveyed away. According to the invention, it is thus possible for a folding station to be integrated in a compact and space-saving manner in a processing installation for printed products. A further advantage is that roller folding formation is also suitable for paper formats with the grain direction transverse to the fold. Finally, in the case of the invention, the folded sheet can easily be kept open by both the sheet ends which are directed away from the fold resting on a bearing surface. In this way, the sheet is transported away in a state in which it is open in the form of a V and can thus be further processed directly without an additional opening step.

The invention is particularly suitable for folding printed paper sheets coming from a digital printing system. Such paper webs usually have a width of approximately 520 mm. Folding produces a fascicle of half the web width. It is also possible to produce smaller fascicle widths without the quality being adversely affected since the folding apparatus according to the invention produces good folds irrespective of the grain direction within the sheet, i.e. even with the grain direction transverse to the fold.

Exemplary embodiments of the process and of the apparatus are described hereinbelow and illustrated in the drawings, in which, duly schematically:

### BRIEF DESCRIPTION OF THE DRAWINGS

FIG. 1a, b show a cross section and a side view of an apparatus according to the invention at the beginning of the operation of folding a sheet;

FIG. 2a, b show a cross section and a side view of an apparatus according to the invention as a sheet is incipiently folded;

FIG. 3a, b show a cross section and a side view of an apparatus according to the invention as a sheet is conveyed away;

FIG. 4a, b show a view from the front and obliquely from the side of an apparatus according to the invention.

### DETAILED DESCRIPTION OF PREFERRED EMBODIMENTS

FIGS. 1a, 1b, 2a, 2b, 3a, 3b each show a cross section (FIG. 1a, 2a, 3a) and a side view (FIG. 1b, 2b, 3b) of an apparatus 1 according to the invention in different states of the folding process according to the invention. The same parts are provided with the same designations.

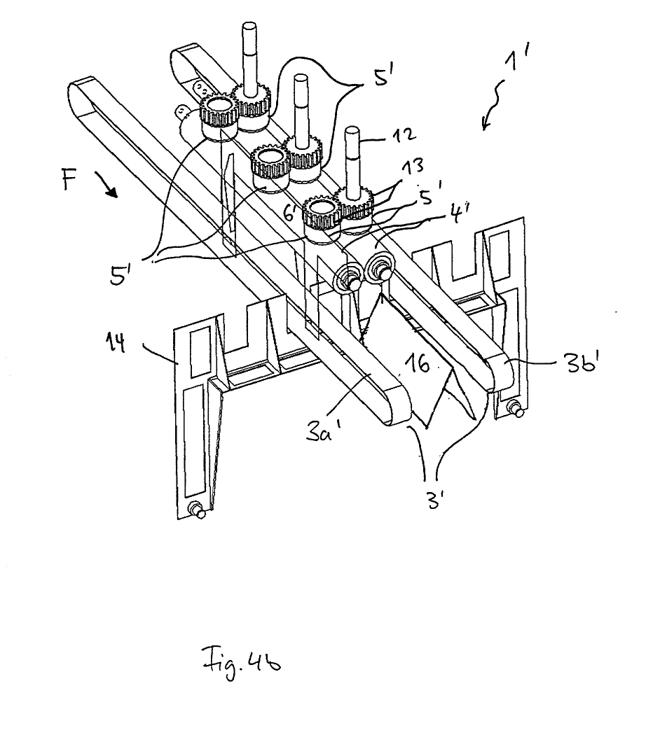

A sheet 2, for folding purposes, is moved, in a state in which it lies horizontally in a feed plane 7, beneath two incipient-folding rollers 4 by a feed arrangement 3 which transports in the conveying direction F. By means of a stop 14, which is only shown in FIGS. 4a, b and is arranged downstream of the incipient-folding rollers 4, the leading edge 2a of the sheet 2 is aligned perpendicularly to the conveying direction F and is positioned beneath the downstream end 4a of the incipient-folding rollers 4. The length of the sheet 2 preferably does not exceed the length of the incipient-folding rollers 4. The feed arrangement 3 comprises at least 2 transporting belts 3a, 3b, which are arranged parallel to one another in the feed plane 7 and transport in the conveying direction F, which runs parallel to the axes of rotation 9 of the incipient-folding rollers 4. A planar knife 6 is arranged in the center between the transporting belts 3a, 3b. The top edge 6a of the knife is aligned in the conveying direction F, and the surface area of the knife is located in a center plane 11 which runs through the center between the incipient-folding rollers 4, perpendicularly to the feed plane 7, and in which the knife 6 is moved for incipient-folding purposes. The direction of the fold 8 is determined by the knife 6 and incipient-folding rollers 4. The top edge 6a of the knife 6 is located first of all beneath the feed plane 7 and thus beneath the sheet 2, see FIGS. 1a, 1b. If the sheet 2 has reached the position beneath the incipient-folding rollers 4, which is shown in FIG. 1b, the feed arrangement 3 is stopped. It is also possible for the sheet 2 to be kept in position, without the feed arrangement 3 being stopped, by means of a vertically displaceable stop.

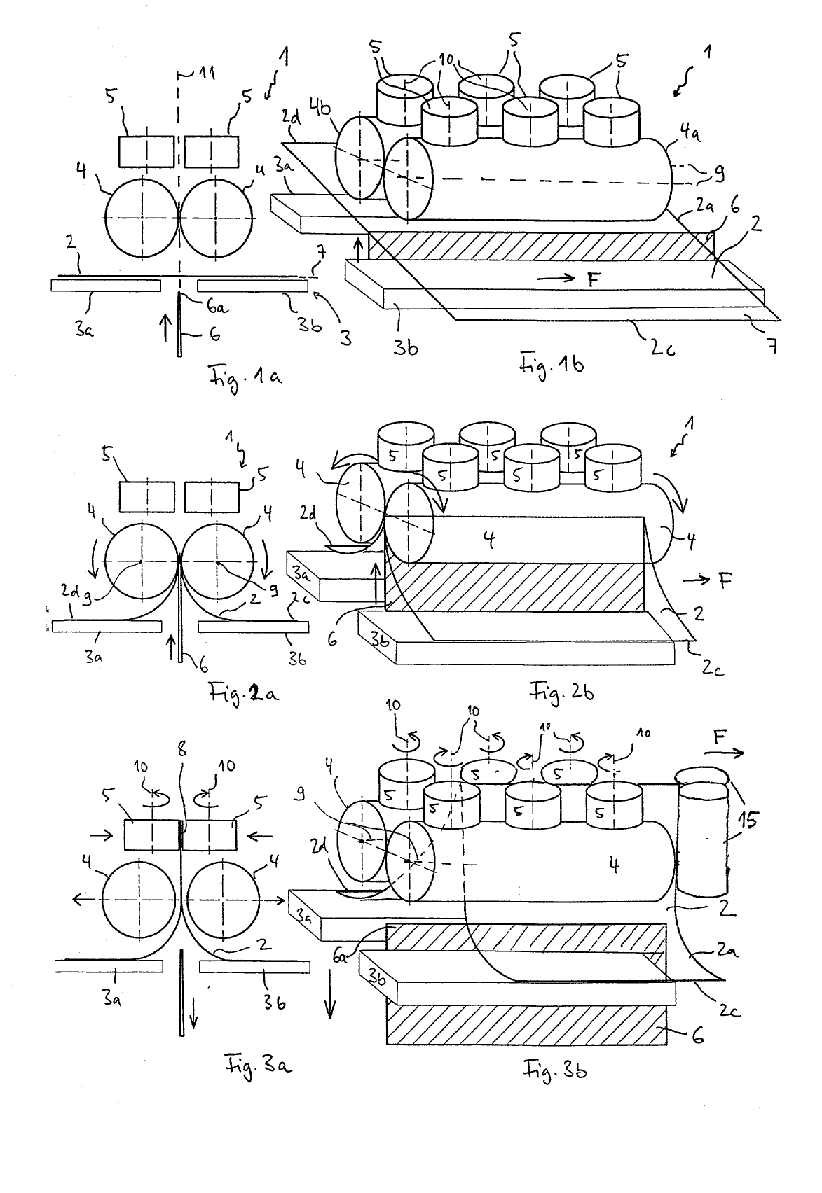

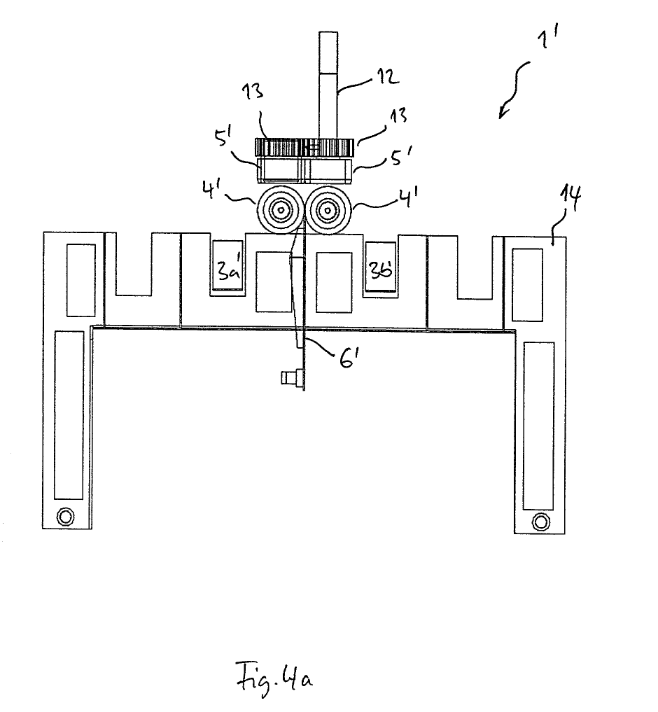

The knife 6 is then moved upward in the center plane 11 and thus forces the sheet 2, in its center, upward and between the incipient-folding rollers 4. This situation is shown in FIGS. 2a, 2b. The incipient-folding rollers 4 are then made to rotate in opposite directions about their axes of rotation 9 and thus draw the sheet 2 upward, a fold 8 being formed in the process. It is also possible for the incipient-folding rollers to run continuously. The incipient-folding rollers 4 are kept in a state in which they are pressed against one another, for example by means of a clamping means, e.g. a spring, at least at this stage of the process. Once the sheet has been gripped by the incipient-folding rollers 4, the knife 6 is moved into its starting position again. The incipient-folding rollers 4 convey the sheet 2 further upward until the fold 8 can be gripped by removal rollers 5, which are arranged above the incipient-folding rollers 4. The removal rollers 5 are arranged at the smallest possible distance from the incipient-folding rollers 4 and can be rotated about axes of rotation 10 running perpendicularly to the feed plane 7. In this case, in each case two removal rollers 5 as well as the incipient-folding rollers 4 are arranged symmetrically to a center plane 11 running through the surface area of the knife. By virtue of in each case two removal rollers 5 being rotated in opposite directions, the sheet is conveyed away in the original feed direction F. In each case two removal rollers 5, which receive the sheet 2 and/or the fold 8 between them, are pressed against one another. As the sheet is conveyed away, the fold 8 is thus improved in one operation, and a very clean, sharp fold is produced. The situation as the sheet is conveyed away is illustrated in FIGS. 3a, 3b.

The incipient-folding rollers 4 are preferably pressed against one another as a sheet 2 is incipiently folded and conveyed in the upward direction, while a gap forms between the removal rollers 5, said gap allowing the folding sheet 2 to be received more easily. Prior to the sheet being conveyed away, and as it is being conveyed away, the removal rollers 5 are pressed against one another and the incipient-folding rollers 4 are moved apart from one another, in order that the removed sheet 2 can easily be drawn through the gap between the incipient-folding rollers 4.

As can be seen from FIGS. 2a, 2b, 3a, 3b, the sheet 2 is not conveyed through the incipient-folding rollers 4 to the full extent. The edges 2c, 2d, which run parallel to the fold 8 and are on the sides, as seen in the conveying direction F, remain beneath the incipient-folding rollers 4 and also rest on the transporting belts 3a, 3b as the sheet is conveyed away. As a result, the sheet 2 is easily kept open during and following the folding operation. It is possible for the sheet, for example as it is conveyed away, to be pushed directly onto a saddle 16 (see FIG. 4b), arranged downstream of the folding apparatus 1, and to be further processed in the open or not completely closed state.

Arranged downstream of the incipient-folding rollers 4 are further removal rollers 15 (only shown in FIG. 3b), of which the axes of rotation are likewise perpendicular to the feed plane 7. The distance of said further removal rollers 15 from the feed plane 7 is smaller than the distance between the removal rollers 5, which are arranged above the incipient-folding rollers 4. The further removal rollers 15 are utilized, in particular, for narrower sheet format. In this case, the further removal rollers extend over the entire height of the incipient-folding rollers, their top end being located level with the removal rollers 5. This has the advantage that any desired paper formats can be definitively folded by the further removal rollers 15 largely irrespective of the height of the fold. If only small sheet formats are to be processed, it is also possible to dispense with the removal rollers 5, which are arranged above the incipient-folding rollers 4.

In the manner outlined, it is also possible for a plurality of sheets which are folded one after the other to be collected in order to be further processed together.

FIGS. 4a, b show a further example of an apparatus according to the invention in a view from the front and obliquely from the side. Located in the bottom region, between two incipient-folding rollers 4′, is a knife 6′ for forcing in the upward direction sheets (not illustrated) fed on a feed arrangement 3′ by at least two parallel transporting belts 3a′, 3b′. The feed arrangement 3′ conveys in the conveying direction F. Said sheets are positioned beneath the incipient-folding rollers 4′ by a vertically displaceable stop 14 aligned transversely to the conveying direction F. A plurality of removal rollers 5′, which are located opposite one another in pairs, are located above the incipient folding rollers 4′. In each case one removal roller 5′ of a pair is driven via a drive rod 12. Gearwheels 13 drive the respectively other removal roller 5′ in the direction of rotation counter to the first removal roller. Other drive variants are conceivable. The feed arrangement 3′ still extends into the region downstream of the arrangement of incipient-folding and removal rollers 4′ and 5′ and also serves for conveying away the folded sheet in the open state. The sheets are pushed onto a saddle 16 by the removal rollers, with the result that they remain open. For the purpose of processing narrow sheet formats, it is also possible to provide further removal rollers, as shown in FIG. 3b.

What is claimed is:

1. A process for folding sheets (2) comprising;
conveying a sheet (2) in a feed direction (F) in a state in which the sheet lies horizontally in a feed plane (7)
feeding the sheet (2) to at least two incipient-folding rollers (4, 4′) by a rectilinear knife (6, 6′), which can be moved perpendicularly to the feed plane (7),
wherein the sheet is received between said rollers in order to form a fold (8),
conveying the folded sheet (2) away in the direction of the fold without completely closing the sheet.

2. The process as claimed in claim 1, wherein, as the sheet is conveyed away, the sheet (2) is positioned on a saddle (16) aligned in the direction of the fold.

3. The process as claimed in claim 1, wherein, once the sheet has been received by the incipient-folding rollers (4, 4′), the sheet (2) is conveyed further by said rollers perpendicularly to the feed plane (7) and then is received between at least two removal rollers (5, 5′) and is conveyed away by the latter in the direction of the fold.

4. The process as claimed in claim 3, wherein the removal rollers (5, 5′) receive the sheet (2) in the region of the fold (8) and convey the sheet away while the lateral borders (2c, 2d) of the sheet (2) are at least partially located between the feed plane (7) and the incipient-folding rollers (4, 4′).

5. The process as claimed in claim 1, wherein the incipient-folding rollers (4, 4′) are pressed against one another as the sheet (2) moves through them and are spaced apart from one another as the sheet (2) is conveyed away.

6. The process as claimed in claim 3, wherein the removal rollers (5, 5′) are pressed against one another as the sheet (2) is conveyed away and are spaced apart from one another as the sheet (2) is conveyed through the incipient-folding rollers (4, 4′).

7. The process as claimed in claim 1, wherein the feed direction (F) and the direction of the fold correspond to one another.

8. The process as claimed in claim 1, further comprising a feed arrangement (3, 3′) for feeding the sheet (2), and for conveying away the folded sheet in the feed direction (F).

9. An apparatus for folding sheets (2) having a knife (6, 6′) which has a rectilinear top edge (6a), located parallel to the feed plane (7), and can be moved perpendicularly to the feed plane (7), having at least two incipient-folding rollers (4, 4′) which are arranged parallel to the feed plane (7) and of which the axes of rotation (9) run parallel to the edge (6a) in each case, and having at least two removal rollers (5, 5′), of which the axes of rotation (10) run perpendicularly to the feed plane (7) and which are arranged on a side of the incipient-folding rollers (4, 4′).

10. The apparatus as claimed in claim 9, which comprises a saddle which is intended for receiving folded sheets (2) and is arranged downstream of the knife (6, 6′).

11. The apparatus as claimed in claim 9, wherein the incipient-folding rollers (4, 4′) can be moved in relation to one another so as to form between them a gap in which the sheet (2) can be displaced as it is conveyed away.

12. The apparatus as claimed in claim 9, which comprises a feed arrangement (3, 3′) for feeding a horizontally lying sheet (2), in a feed direction (F), into the region between the knife (6, 6′) and the incipient-folding rollers (4, 4′).

13. The apparatus as claimed in claim 12, wherein the top edge (6a) of the knife (6, 6′) is aligned in the feed direction (F).

14. The apparatus as claimed in claim 12, wherein the feed arrangement (3, 3′) comprises at least two transporting belts (3a, 3b, 3a′, 3b′) which are arranged to the sides of the knife (6), parallel to the knife (6).

15. The apparatus as claimed in claim 9, which comprises a stop for feed sheets (2), said stop being arranged in the feed plane (7) downstream of the knife (6, 6′) and perpendicularly to the feed direction (F).

16. The apparatus as claimed in claim 9, wherein the distance of the removal rollers (5, 5′) from the feed plane (7) is less than half the sheet width.

17. The process as claimed in claim 1 wherein the folded sheet is conveyed away while end portions of the sheet remain parallel to the feed plane.

18. The apparatus of claim 9 wherein the removal rollers direct the sheet to the side of the incipient-folding rollers.

19. The apparatus of claim 9 wherein the removal rollers direct the sheet to the side of the incipient-folding rollers that is away from the feed plane.

20. The process of claim 1, wherein the sheet is folded with a grain direction transverse to the fold.

21. The apparatus of claim 9, wherein the sheet is folded with a grain direction transverse to the fold.
